(19) United States
(12) Patent Application Publication
(10) Pub. No.: US 2026/0094088 A1
(43) Pub. Date: Apr. 2, 2026

(54) SUPERVISED MACHINE LEARNING MODEL FOR DETERMINING STAFFING LEVELS

(71) Applicant: NCR Voyix Corporation, Atlanta, GA (US)

(72) Inventors: Tamar Miriam Haizler, Kfar-Saba (IL); Shiran Abadi, Tel-Aviv (IL)

(21) Appl. No.: 18/902,583

(22) Filed: Sep. 30, 2024

(51) Int. Cl. G06Q 10/0631; G06Q 10/0639

(52) U.S. Cl. CPC G06Q 10/06312; G06Q 10/06393

(57) ABSTRACT

System and techniques may be used for classifying staffing levels using a trained supervised machine learning model. An example technique may include generating a training dataset including input data corresponding to sales data at a store over a time period, training a supervised regression machine learning model using the training dataset, generating an inference dataset, and predicting, using the supervised regression machine learning model, an expected number of cashiers for a subset of data from the inference dataset corresponding to a particular time in the past. The example technique may include comparing an actual number of cashiers at the particular time to the expected number of cashiers, and outputting an indication of whether the store was overstaffed, understaffed, or adequately staffed based on a result of comparing the actual number of cashiers at the particular time to the expected number of cashiers.

### BACKGROUND

A good labor scheduling is crucial for a store to operate successfully and efficiently. It directly affects employees and customers experience and satisfaction. However, it is difficult to identify and categorize staffing levels without direct information from the store owner or manual examination.

### SUMMARY

In various embodiments, methods and systems for classifying staffing levels using a trained supervised machine learning model.

According to an embodiment, a technique may include generating a training dataset including input data corresponding to sales data at a store over a time period. The training dataset may be labeled with a corresponding number of cashiers working at front-end lanes at respective time increments in the time period. The technique may include removing outliers from the training dataset using an outlier detection model to generate a clean labeled training dataset. A supervised regression machine learning model may be trained using the clean labeled training dataset. The technique may include generating an inference dataset, similar to the training dataset, for a particular time in the past. The technique may include predicting, using the supervised regression machine learning model, an expected number of cashiers for the inference dataset corresponding to a particular time. An actual number of cashiers at the particular time may be compared to the expected number of cashiers. The technique may include outputting an indication of whether the store was overstaffed, understaffed, or adequately staffed based on a result of comparing the actual number of cashiers at the particular time to the expected number of cashiers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for classifying staffing levels using a trained supervised machine learning model in accordance with some embodiments.

FIG. 2 illustrates generally an example store with staff and customers in accordance with some embodiments.

FIG. 3 illustrates generally a block diagram for classifying staffing levels in accordance with some embodiments.

FIG. 4 illustrates machine learning engine for training and execution related to classifying staffing levels in accordance with some embodiments.

FIG. 5 illustrates generally a flowchart showing a technique for classifying staffing levels using a trained supervised machine learning model in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein may be used for classifying staffing levels using a trained supervised machine learning model. The trained supervised machine learning model may be used to output a prediction of how many cashiers should be used in a store at a given time or for a given period of time based on store metrics. This prediction may be compared to an actual number of clerks for the given time or given time period (e.g., after the time or time period has passed) to classify the time or time period for the store as understaffed, overstaffed, or adequately staffed.

The machine learning model may be used to categorize staffing levels of a store in a specific time using commerce data. The model may use past staffing data, for example staffing data related to assisted service lanes of a store, transactional data of the assisted service lanes, etc. The model may be trained to learn a relationship between a current staffing status, such as number of cashiers, and one or more other various aspects of the store, during a specific time unit (e.g. an hour, a shift, etc.). Staffing levels may be derived from a difference between actual staffing status and predicted staffing status (e.g., by the model).

When working on capacity management for a retail store, it is useful to know when the store was adequately staffed, when it was understaffed, and when it was overstaffed. Given the relevant tracking, employees may be called in to support the traffic at the store or sent home when there is more staff than needed. This may present a great impact of the store labor hours and maximize shopper satisfaction while minimizing store expenses on labor. However, previous solutions were entirely subjective based on human considerations.

The systems and techniques described herein rely on an objective trained model to define the number of cashiers based on one or more store metrics, which may be compared to an actual number of cashiers. This technical solution does not set restrictive prior assumptions on the data and may be applied to any retail chain, given reliable commerce data.

In some examples, time units used may include five minutes, fifteen minutes, an hour, eight hour shift, or the like chosen according to business logic. The staffing level may be derived from a number of cashiers that were active (e.g., processed one or more transactions) for the time unit. In this context, a cashier may be defined as an employee who processes one or more transactions in a payment lane (hereafter “front-end” lanes) of a store. Other touchpoints, such as a bakery or meat department, clean-up, or warehouse work are also staffed, but usually they are assigned with an employee regardless of the traffic in the store. For this reason they do not affect the staffing level of the store. The disclosed machine learning model herein may be applied to any type of touchpoint group, such as when the characteristics are similar to a store staffing level. Training data for the model may include transactional data from stores (e.g., around one hundred stores) over a period of time, such as one month. The systems and techniques described herein may provide a staffing level categorization for a new store, when the new store is similar to other stores used to train the model. In some examples, the model may be trained for a chain store.

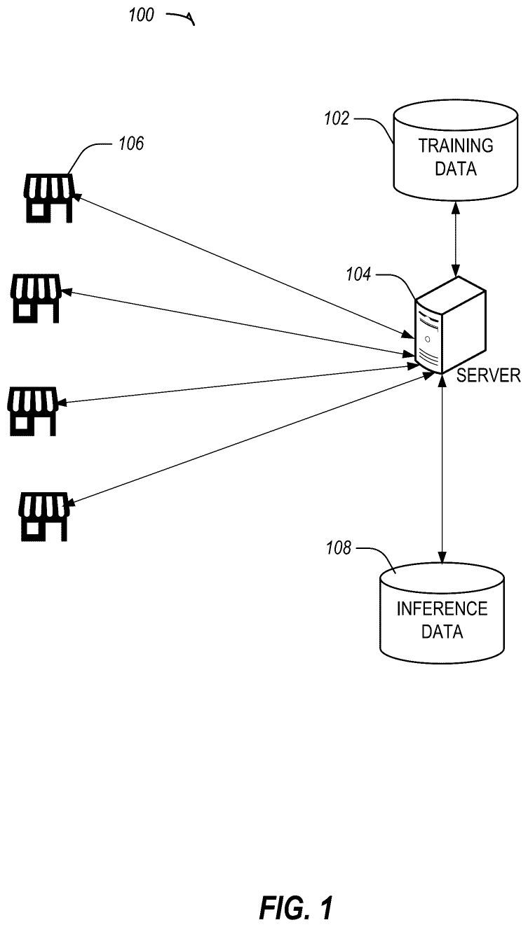

FIG. 1 illustrates a system 100 for classifying staffing levels using a trained supervised machine learning model in accordance with some embodiments. The system 100 includes a set of stores 106, which communicate data to a server 104. The server 104 may include or be communicatively coupled to one or more databases, such as a training database 102 or an inference database 108. The training database 102 may store data used to train a model, for example using data from the set of stores 106 (e.g., actual number of cashiers, metadata, transaction data, etc.). The inference database 108 may store data used to predict a staffing level (e.g., using the trained model), data related to an actual staffing level, a comparison of predicted to actual staffing level, store metadata, or the like. The server 104 may receive actual staffing data from a store of the set of stores 106 and send an indication in response (e.g., using the trained model) of whether the store for a particular time period was overstaffed, understaffed, or adequately staffed. As used herein, adequately staffed means not overstaffed or understaffed (e.g., exactly staffed as predicted or within a range of the prediction, such as one, two, three, etc., more or fewer cashiers than predicted).

The server 104 may build a training dataset for storage in the training database 102. This dataset may include data from the set of stores 106, for example over a sufficiently long period of time (e.g., a week, a month, a year, etc.). Each sample in the dataset may represent a time period (e.g., one hour of a day per store, such as May 5th between 7-8, 8-9, . . . May 6th between 7-8, etc.). The dataset may include one or more various measures describing the status of a store in that specific time period, and a number of cashiers who worked at the front-end lanes during the specific time period. The number of cashiers may be used as a label for training the model.

The server 104 may clean outliers from the data. Removing outliers is useful to avoid training the model on hours in which the behavior in a store was abnormal. This allows the model to learn a typical relationship between staffing and other aspects of the store, such as traffic. Assuming that the store operators know the number of required staff for most of the operating hours, the rare samples are likely hours in which the staffing was not adequate. Removing outliers assists in removing those samples from the training set in order to train the model mostly on an adequate level samples. An outlier detection model (e.g., an Isolation Forest algorithm) may be used to detect anomalous hours and remove them from the training set. For example, on July 4th in the United States, the traffic may be excessively larger or smaller due to the holiday, and such behavior does not characterize the usual status of a store. Anomalous data may be included in the inference dataset, since these are potentially the times that may be more likely to be categorized as understaffed or overstaffed.

The server 104 may train a supervised regression machine learning model, such as a Tree-based model, with the clean training set (e.g., as stored in the training database 102). Given the set of measures, the model may be trained to predict an expected number of cashiers per some store per time period. The store may be one of the set of stores 106 or may be a different store outside the set of stores 106 (e.g., a newly opened store for a chain of stores).

The server may build an inference dataset and store the inference dataset in the inference database 108. The inference dataset may be generated in the same manner as the training set, such as for different samples (e.g., a different store, a different time period, etc.). Unlike the training set, outliers do not need to be removed (they may be removed, optionally). In the inference phase, outliers do not bias the model. The actual number of cashiers is excluded from the inference set.

The server 104 may predict an expected number of cashiers for the inference set samples using the trained model. The server 104 may compare the actual number of cashiers (e.g., as received from the store) to the predicted number by the model for a store and time period. The server 104 may determine a staffing level category from the difference between predicted number of cashiers and actual number, for example including overstaffed, understaffed, or adequately staffed.

Features for training the model may include one or more metrics from the set of stores 106. One or more of various options for features that may contribute to the ability of the model to learn the expected number of cashiers may be used. Some features may represent a metric that is calculated for each group of lanes separately, (e.g., front-end lanes, assisted non front-end lanes (such as bakery or front desk), or self-checkout (SCO) lanes). These features may be used to determine a status of the store from available transactional data. The selected measures (per store and per time period) for the model may include one or more of: a number of cashiers in other assisted non front-end lanes, a number of active touchpoints for each group of lanes, a percentage idle time at front-end lanes (e.g., a percentage of time no transaction has been processed), an average time between consecutive transactions at front-end lanes, a total number of items that were processed for each group of lanes, a binary feature that indicates whether there was a touchpoint that was open for a brief time window (e.g., to capture a business phenomenon of a lane opening briefly to support unexpected and sudden customer demand), a percentage of lanes that are busy (e.g., according to a rule-based definition of a busy lane, for example an hour may be categorized as understaffed when most of the front-end lanes are actually busy), or any other feature that can imply on the required number of cashiers at the store at that time. A number of distinct cashiers that were active in the front-end lanes in the time period may be used as a label for the model. In some examples, the model may predict a non-round number of cashiers (e.g., 4.2 cashiers). In these cases, labor hours may be used instead of number of cashiers (e.g., replace 1.5 cashiers with 90 minutes), or the prediction may be rounded (e.g., replace 4.2 cashiers with 4 cashiers).

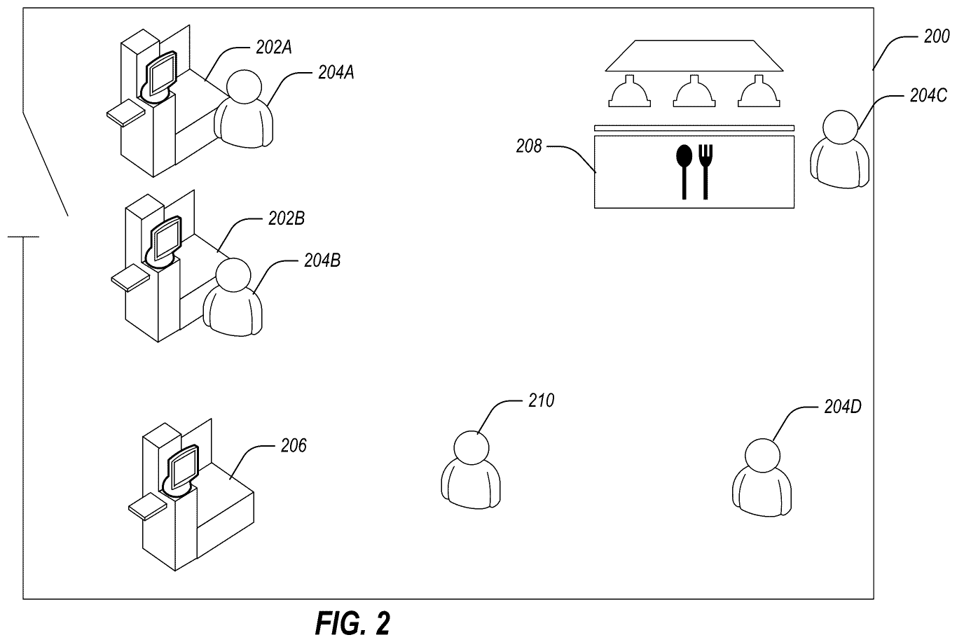

FIG. 2 illustrates generally an example store 200 with staff and customers in accordance with some examples. The store 200 includes two front-end lanes 202A-202B, where cashiers 204A-204B operate to process customer transactions. The front-end lanes 202A-202B are locations where customers complete their purchases, and the cashiers 204A-204B are responsible for scanning items, handling payments, providing receipts, etc. The store 200 includes another lane 206, which may be an idle front-end lane or a self-service checkout. The store 200 includes employees 204C-204D not working at the front-end lanes 202A-202B, such as an employee 204C found at a deli service 208, or an employee 204D stocking shelves.

A customer 210 is shown in the store 200, engaging in various activities such as shopping for items, waiting in line at the front-end lanes 202A-202B, or interacting with employees 204A-204D. The behavior and number of customers may impact the workload of the cashiers 204A-204B affecting the staffing requirements of the store 200. The percentage of idle time at the front-end lanes 202A-202B, the average time between consecutive transactions at the front-end lanes 202A-202B, and the total number of items processed at each group of lanes are metrics that may be used to train the supervised regression machine learning model. The store may include a customer service point that opens for a short period to handle a sudden increase in customer traffic.

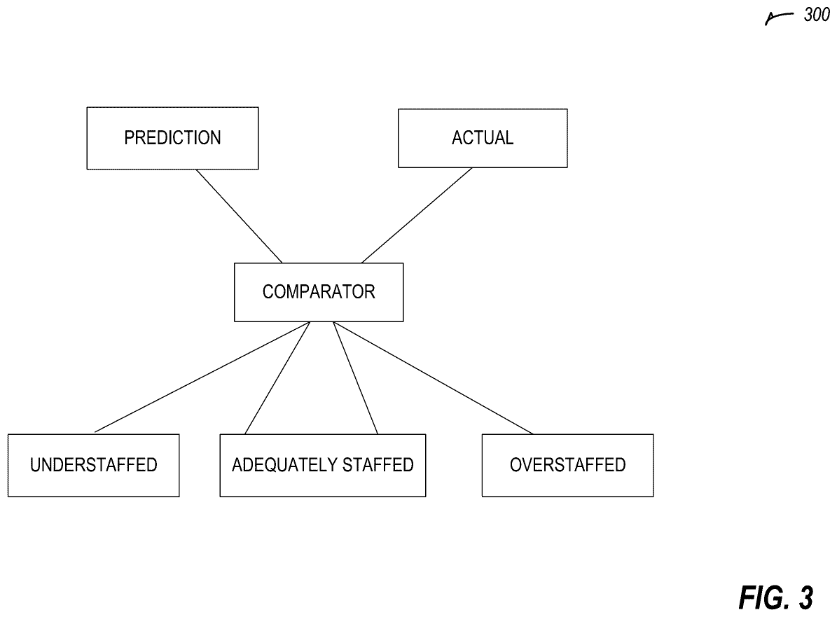

FIG. 3 illustrates generally a block diagram 300 for classifying staffing levels in accordance with some embodiments. The block diagram 300 comprises several components, including a block indicating a predicted staffing level, a block indicating an actual staffing level, a comparator, an understaffed indicator, an adequately staffed indicator, and an overstaffed indicator.

The block indicating the predicted staffing level may include a prediction from a machine learning trained model including an output of an expected number of cashiers for a store from an inference dataset corresponding to a particular time. This block may use a supervised regression machine learning model to output the prediction, as described herein. The block indicating the actual staffing level includes information corresponding to an actual number of cashiers at the store the particular time. The comparator compares the actual number of cashiers at the particular time to the expected number of cashiers. This comparison determines the staffing level of the store. The comparator generates an indication of whether the actual number of cashiers at the particular time exceeds, is lower than, or is equal to the expected number of cashiers. Further processing at the comparator block may include identifying a range indicating the store was adequately staffed that includes one or more cashiers above or below the expected number of cashiers.

The understaffed indicator indicates that the store was understaffed when the actual number of cashiers at the particular time is lower than the expected number of cashiers or lower than a range around the expected number of cashiers. This indicator helps a store manager identify a period of time when additional staffing would have been helpful to meet customer demand. The adequately staffed indicator indicates that the store was adequately staffed when the actual number of cashiers at the particular time is equal to or within a range around the expected number of cashiers. The overstaffed indicator indicates that the store was overstaffed when the actual number of cashiers at the particular time exceeds the expected number of cashiers or greater than a range around the expected number of cashiers. This indicator helps store managers identify periods when staffing levels may be reduced to optimize labor costs.

When a prediction is available for a particular store at a particular time period, the prediction may be interpretated using the comparison. A staffing level may be derived from the comparison between the predicted and actual number of cashiers. When the predicted and actual numbers are close, the store may be indicated to be adequately staffed during the time period. When the actual number of cashiers is lower than predicted (e.g., by at least threshold), the store was understaffed. When the actual number is higher than the prediction, the store was overstaffed. For example, for a specific store and time period, the model may predict that there are 5 cashiers, suggesting that 5 cashiers are required to support the traffic at the store, but there were actually 2, which indicates that during the time period, the store was understaffed. A user (e.g., a store manager, owner, etc.) may indicate an allowed tolerance, for example, a deviation of up to two cashiers is allowed for a particular time period (or any time period) to be considered as adequately staffed.

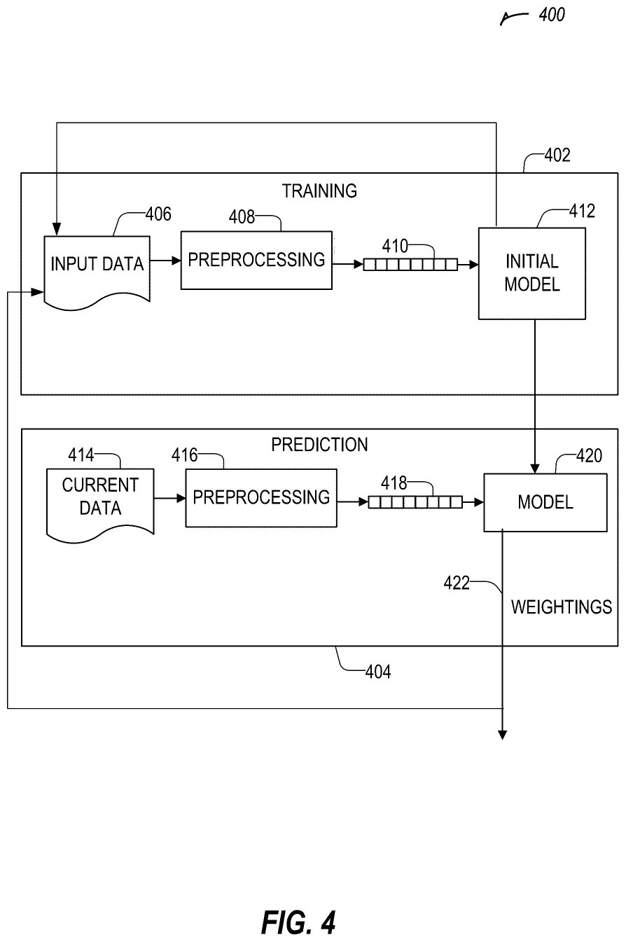

FIG. 4 illustrates machine learning engine for training and execution related to classifying staffing levels in accordance with some embodiments. The machine learning engine may be deployed to execute at a mobile device (e.g., a cell phone, a tablet, etc.) or a computer (e.g., a desktop, a laptop, etc.). FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include data from one or more stores at one or more time intervals. The data may include a number of cashiers in other assisted non front-end lanes, a number of active touchpoints for each group of lanes, a percentage idle time at front-end lanes (e.g., a percentage of time no transaction has been processed), an average time between consecutive transactions at front-end lanes, a total number of items that were processed for each group of lanes, a binary feature that indicates whether there was a touchpoint that was open for a brief time window (e.g., to capture a business phenomenon of a lane opening briefly to support unexpected and sudden customer demand), a percentage of lanes that are busy (e.g., according to a rule-based definition of a busy lane, for example an hour may be categorized as understaffed when most of the front-end lanes are actually busy), or the like.

In the prediction engine 404, current data 414 (e.g., inference data from a particular store at a particular time) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include a number of distinct cashiers that were active in the front-end lanes in a time period at a particular store.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests (e.g., a random forest regressor, an isolation forest, etc.), linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a prediction, such as a predicted number of cashiers or an indication of whether a store was understaffed, overstaffed, or adequately staffed (e.g., after undergoing an additional post-model comparison). A model used to generate a prediction may include a random forest regressor as a prediction model for the number of cashiers. A mean absolute percent error (MAPE) may be used to evaluate the accuracy of the model.

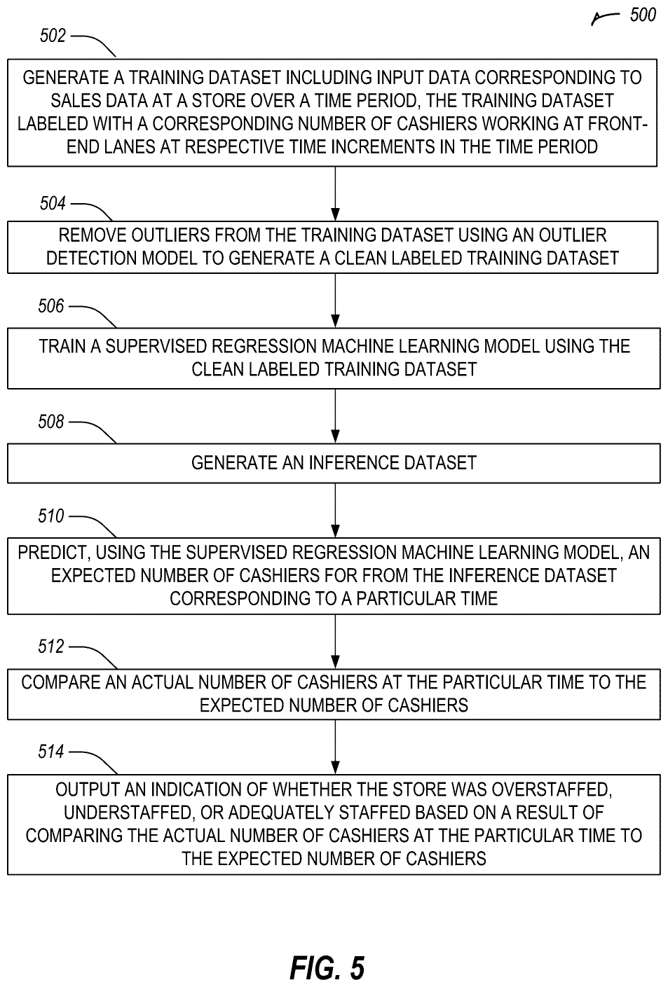

FIG. 5 illustrates generally a flowchart showing a technique 500 for classifying staffing levels using a trained supervised machine learning model in accordance with some embodiments.

The technique 500 includes an operation 502 to generate a training dataset including input data corresponding to sales data at a store over a time period, the training dataset labeled with a corresponding number of cashiers working at front-end lanes at respective time increments (e.g., per minute, every fifteen minutes, hourly, per shift, per day, etc.) in the time period. The input data may include at least one of a number of cashiers in non-front-end lanes, a number of active touchpoints for each group of lanes, a percent idle time of cashiers at front-end lanes, an average time between consecutive transactions at front-end lanes, a total number of items that were processed for each group of lanes, a binary feature indicating whether there was a touchpoint that was open for a time increment shorter than the respective time increments, a percentage of busy lanes based on a busy lanes rule, or the like.

The technique 500 includes an operation 504 to remove outliers from the training dataset using an outlier detection model to generate a clean labeled training dataset. The technique 500 includes an operation 506 to train a supervised regression machine learning model (e.g., a random forest regressor) using the clean labeled training dataset. The technique 500 includes an operation 508 to generate an inference dataset. The inference dataset may include one or more outliers that are not removed (e.g., unlike the clean labeled training dataset). The technique 500 includes an operation 510 to predict, using the supervised regression machine learning model (e.g., an isolation forest model), an expected number of cashiers for data from the inference dataset corresponding to a particular time.

The technique 500 includes an operation 512 to compare an actual number of cashiers at the particular time to the expected number of cashiers. The technique 500 includes an operation 514 to output an indication of whether the store was overstaffed, understaffed, or adequately staffed based on a result of comparing the actual number of cashiers at the particular time to the expected number of cashiers. In an example, operation 512 includes generating an indication of whether the actual number of cashiers at the particular time exceeds, is lower than, or is equal to the expected number of cashiers. In this example, operation 514 may include outputting the indication that the store was overstaffed when the actual number of cashiers at the particular time exceeds the expected number of cashiers, understaffed when the actual number of cashiers at the particular time is lower than the expected number of cashiers, and adequately staffed when the actual number of cashiers at the particular time is equal to the expected number of cashiers. Operation 514 may include using a tolerance deviation for adequately staffed of up to two cashiers difference between the actual number of cashiers and the expected number of cashiers.

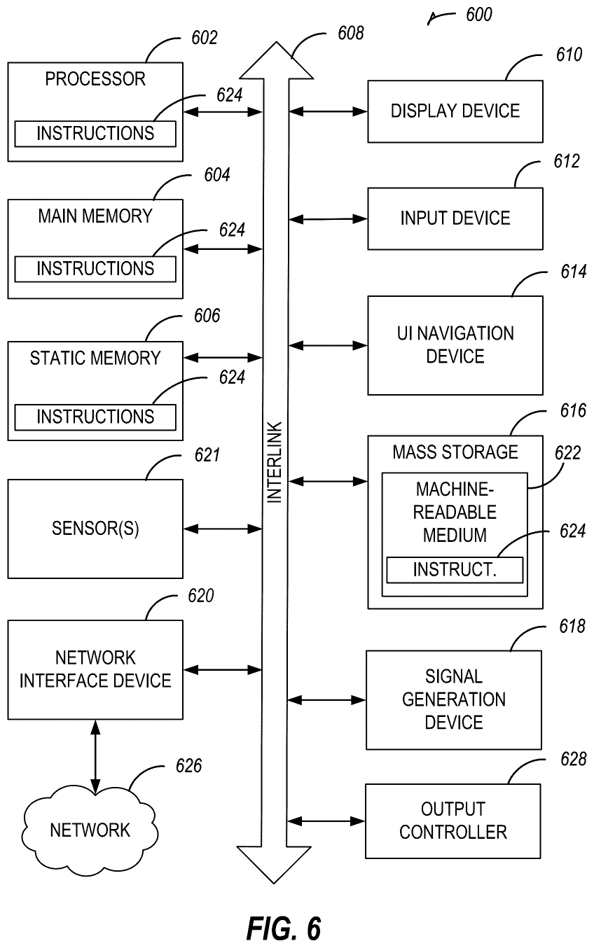

FIG. 6 illustrates generally an example of a block diagram of a machine 600 upon which any one or more of the techniques discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

Each of these non-limiting examples may stand on its own, or may be combined in various permutations or combinations with one or more of the other examples.

Example 1 is a method comprising: generating a training dataset including input data corresponding to sales data at a store over a time period, the training dataset labeled with a corresponding number of cashiers working at front-end lanes at respective time increments in the time period; removing outliers from the training dataset using an outlier detection model to generate a clean labeled training dataset; training a supervised regression machine learning model using the clean labeled training dataset; generating an inference dataset; predicting, using the supervised regression machine learning model, an expected number of cashiers for a subset of data from the inference dataset corresponding to a particular time; comparing an actual number of cashiers at the particular time to the expected number of cashiers; and outputting an indication of whether the store was overstaffed, understaffed, or adequately staffed based on a result of comparing the actual number of cashiers at the particular time to the expected number of cashiers.

In Example 2, the subject matter of Example 1 includes, wherein the respective time increments are hourly or per cashier shift.

In Example 3, the subject matter of Examples 1-2 includes, wherein the outlier detection model is an isolation forest model.

In Example 4, the subject matter of Examples 1-3 includes, wherein the supervised regression machine learning model is a random forest regressor.

In Example 5, the subject matter of Examples 1-4 includes, wherein the inference dataset includes one or more outliers that are not removed.

In Example 6, the subject matter of Examples 1-5 includes, wherein comparing the actual number of cashiers at the particular time to the expected number of cashiers includes generating an indication of whether the actual number of cashiers at the particular time exceeds, is lower than, or is equal to the expected number of cashiers.

In Example 7, the subject matter of Example 6 includes, wherein outputting the indication includes outputting the indication that the store was overstaffed when the actual number of cashiers at the particular time exceeds the expected number of cashiers, understaffed when the actual number of cashiers at the particular time is lower than the expected number of cashiers, and adequately staffed when the actual number of cashiers at the particular time is equal to the expected number of cashiers.

In Example 8, the subject matter of Examples 1-7 includes, wherein outputting the indication of whether the store was overstaffed, understaffed, or adequately staffed includes using a tolerance deviation for adequately staffed of up to two cashiers difference between the actual number of cashiers and the expected number of cashiers.

In Example 9, the subject matter of Examples 1-8 includes, wherein the input data from training dataset includes at least one of a number of cashiers in non-front-end lanes, a number of active touchpoints for each group of lanes, a percent idle time of cashiers at front-end lanes, an average time between consecutive transactions at front-end lanes, a total number of items that were processed for each group of lanes, a binary feature indicating whether there was a touchpoint that was open for a time increment shorter than the respective time increments, or a percentage of busy lanes based on a busy lanes rule.

Example 10 is at least one non-transitory machine-readable medium including instructions, which when executed by processing circuitry, cause the processing circuitry to perform operations comprising: generating a training dataset including input data corresponding to sales data at a store over a time period, the training dataset labeled with a corresponding number of cashiers working at front-end lanes at respective time increments in the time period; removing outliers from the training dataset using an outlier detection model to generate a clean labeled training dataset; training a supervised regression machine learning model using the clean labeled training dataset; generating an inference dataset; predicting, using the supervised regression machine learning model, an expected number of cashiers for a subset of data from the inference dataset corresponding to a particular time; comparing an actual number of cashiers at the particular time to the expected number of cashiers; and outputting an indication of whether the store was overstaffed, understaffed, or adequately staffed based on a result of comparing the actual number of cashiers at the particular time to the expected number of cashiers.

In Example 11, the subject matter of Example 10 includes, wherein the respective time increments are hourly or per cashier shift.

In Example 12, the subject matter of Examples 10-11 includes, wherein the outlier detection model is an isolation forest model.

In Example 13, the subject matter of Examples 10-12 includes, wherein the supervised regression machine learning model is a random forest regressor.

In Example 14, the subject matter of Examples 10-13 includes, wherein the inference dataset includes one or more outliers that are not removed.

In Example 15, the subject matter of Examples 10-14 includes, wherein comparing the actual number of cashiers at the particular time to the expected number of cashiers includes generating an indication of whether the actual number of cashiers at the particular time exceeds, is lower than, or is equal to the expected number of cashiers.

In Example 16, the subject matter of Example 15 includes, wherein outputting the indication includes outputting the indication that the store was overstaffed when the actual number of cashiers at the particular time exceeds the expected number of cashiers, understaffed when the actual number of cashiers at the particular time is lower than the expected number of cashiers, and adequately staffed when the actual number of cashiers at the particular time is equal to the expected number of cashiers.

In Example 17, the subject matter of Examples 10-16 includes, wherein outputting the indication of whether the store was overstaffed, understaffed, or adequately staffed includes using a tolerance deviation for adequately staffed of up to two cashiers difference between the actual number of cashiers and the expected number of cashiers.

In Example 18, the subject matter of Examples 10-17 includes, wherein the input data from training dataset includes at least one of a number of cashiers in non-front-end lanes, a number of active touchpoints for each group of lanes, a percent idle time of cashiers at front-end lanes, an average time between consecutive transactions at front-end lanes, a total number of items that were processed for each group of lanes, a binary feature indicating whether there was a touchpoint that was open for a time increment shorter than the respective time increments, or a percentage of busy lanes based on a busy lanes rule.

Example 19 is a system comprising: processing circuitry; and memory, including instructions, which when executed by the processing circuitry, cause the processing circuitry to perform operations comprising: generating a training dataset including input data corresponding to sales data at a store over a time period, the training dataset labeled with a corresponding number of cashiers working at front-end lanes at respective time increments in the time period; removing outliers from the training dataset using an outlier detection model to generate a clean labeled training dataset; training a supervised regression machine learning model using the clean labeled training dataset; generating an inference dataset; predicting, using the supervised regression machine learning model, an expected number of cashiers for a subset of data from the inference dataset corresponding to a particular time; comparing an actual number of cashiers at the particular time to the expected number of cashiers; and outputting an indication of whether the store was overstaffed, understaffed, or adequately staffed based on a result of comparing the actual number of cashiers at the particular time to the expected number of cashiers.

In Example 20, the subject matter of Example 19 includes, wherein the respective time increments are hourly or per cashier shift.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
generating a training dataset including input data corresponding to sales data at a store over a time period, the training dataset labeled with a corresponding number of cashiers working at front-end lanes at respective time increments in the time period;
removing outliers from the training dataset using an outlier detection model to generate a clean labeled training dataset;
training a supervised regression machine learning model using the clean labeled training dataset;
generating an inference dataset;
predicting, using the supervised regression machine learning model, an expected number of cashiers for a subset of data from the inference dataset corresponding to a particular time;
comparing an actual number of cashiers at the particular time to the expected number of cashiers; and
outputting an indication of whether the store was overstaffed, understaffed, or adequately staffed based on a result of comparing the actual number of cashiers at the particular time to the expected number of cashiers.

2. The method of claim 1, wherein the respective time increments are hourly or per cashier shift.

3. The method of claim 1, wherein the outlier detection model is an isolation forest model.

4. The method of claim 1, wherein the supervised regression machine learning model is a random forest regressor.

5. The method of claim 1, wherein the inference dataset includes one or more outliers that are not removed.

6. The method of claim 1, wherein comparing the actual number of cashiers at the particular time to the expected number of cashiers includes generating an indication of whether the actual number of cashiers at the particular time exceeds, is lower than, or is equal to the expected number of cashiers.

7. The method of claim 6, wherein outputting the indication includes outputting the indication that the store was overstaffed when the actual number of cashiers at the particular time exceeds the expected number of cashiers, understaffed when the actual number of cashiers at the particular time is lower than the expected number of cashiers, and adequately staffed when the actual number of cashiers at the particular time is equal to the expected number of cashiers.

8. The method of claim 1, wherein outputting the indication of whether the store was overstaffed, understaffed, or adequately staffed includes using a tolerance deviation for adequately staffed of up to two cashiers difference between the actual number of cashiers and the expected number of cashiers.

9. The method of claim 1, wherein the input data from training dataset includes at least one of a number of cashiers in non-front-end lanes, a number of active touchpoints for each group of lanes, a percent idle time of cashiers at front-end lanes, an average time between consecutive transactions at front-end lanes, a total number of items that were processed for each group of lanes, a binary feature indicating whether there was a touchpoint that was open for a time increment shorter than the respective time increments, or a percentage of busy lanes based on a busy lanes rule.

10. At least one non-transitory machine-readable medium including instructions, which when executed by processing circuitry, cause the processing circuitry to perform operations comprising:
generating a training dataset including input data corresponding to sales data at a store over a time period, the training dataset labeled with a corresponding number of cashiers working at front-end lanes at respective time increments in the time period;
removing outliers from the training dataset using an outlier detection model to generate a clean labeled training dataset;
training a supervised regression machine learning model using the clean labeled training dataset;
generating an inference dataset;
predicting, using the supervised regression machine learning model, an expected number of cashiers for a subset of data from the inference dataset corresponding to a particular time;
comparing an actual number of cashiers at the particular time to the expected number of cashiers; and
outputting an indication of whether the store was overstaffed, understaffed, or adequately staffed based on a result of comparing the actual number of cashiers at the particular time to the expected number of cashiers.

11. The at least one non-transitory machine-readable medium of claim 10, wherein the respective time increments are hourly or per cashier shift.

12. The at least one non-transitory machine-readable medium of claim 10, wherein the outlier detection model is an isolation forest model.

13. The at least one non-transitory machine-readable medium of claim 10, wherein the supervised regression machine learning model is a random forest regressor.

14. The at least one non-transitory machine-readable medium of claim 10, wherein the inference dataset includes one or more outliers that are not removed.

15. The at least one non-transitory machine-readable medium of claim 10, wherein comparing the actual number of cashiers at the particular time to the expected number of cashiers includes generating an indication of whether the actual number of cashiers at the particular time exceeds, is lower than, or is equal to the expected number of cashiers.

16. The at least one non-transitory machine-readable medium of claim 15, wherein outputting the indication includes outputting the indication that the store was overstaffed when the actual number of cashiers at the particular time exceeds the expected number of cashiers, understaffed when the actual number of cashiers at the particular time is lower than the expected number of cashiers, and adequately staffed when the actual number of cashiers at the particular time is equal to the expected number of cashiers.

17. The at least one non-transitory machine-readable medium of claim 10, wherein outputting the indication of whether the store was overstaffed, understaffed, or adequately staffed includes using a tolerance deviation for adequately staffed of up to two cashiers difference between the actual number of cashiers and the expected number of cashiers.

18. The at least one non-transitory machine-readable medium of claim 10, wherein the input data from training dataset includes at least one of a number of cashiers in non-front-end lanes, a number of active touchpoints for each group of lanes, a percent idle time of cashiers at front-end lanes, an average time between consecutive transactions at front-end lanes, a total number of items that were processed for each group of lanes, a binary feature indicating whether there was a touchpoint that was open for a time increment shorter than the respective time increments, or a percentage of busy lanes based on a busy lanes rule.

19. A system comprising:
processing circuitry; and
memory, including instructions, which when executed by the processing circuitry, cause the processing circuitry to perform operations comprising:
generating a training dataset including input data corresponding to sales data at a store over a time period, the training dataset labeled with a corresponding number of cashiers working at front-end lanes at respective time increments in the time period;
removing outliers from the training dataset using an outlier detection model to generate a clean labeled training dataset;
training a supervised regression machine learning model using the clean labeled training dataset;
generating an inference dataset;
predicting, using the supervised regression machine learning model, an expected number of cashiers for a subset of data from the inference dataset corresponding to a particular time;
comparing an actual number of cashiers at the particular time to the expected number of cashiers; and
outputting an indication of whether the store was overstaffed, understaffed, or adequately staffed based on a result of comparing the actual number of cashiers at the particular time to the expected number of cashiers.

20. The system of claim 19, wherein the respective time increments are hourly or per cashier shift.
